(19) United States
(12) Patent Application Publication
(10) Pub. No.: US 2016/0036653 A1
(43) Pub. Date: Feb. 4, 2016

(54) METHOD AND APPARATUS FOR AVOIDING PERFORMANCE DECREASE IN HIGH AVAILABILITY CONFIGURATION

(71) Applicant: HITACHI, LTD., Chiyoda-ku, Tokyo (JP)

(72) Inventor: Akira DEGUCHI, Santa Clara, CA (US)

(21) Appl. No.: 14/774,098

(22) PCT Filed: Nov. 5, 2013
(86) PCT No.: PCT/US13/68562

§ 371 Date: Sep. 9, 2015

(51) Int. Cl. H04L 12/24; G06F 3/06; H04L 29/08

(52) U.S. Cl. CPC H04L 41/5025; H04L 67/1097; H04L 67/16; G06F 3/061; G06F 3/0635; G06F 3/0683

(57) ABSTRACT

Example implementations described herein are directed to a first storage system that provides a first volume with an identifier to a server. The first volume is communicatively coupled to the server through a first path with a first status, which can be active or passive. There is a second storage system that provides a second volume with the same identifier to the server. The second volume is communicatively coupled to the server through a second path with a second status, which can be active or passive. The first storage system sends a first instruction to the server to change the second status from active to passive and sends a second instruction to the second storage system to start executing a function, which accesses the second volume.

### BACKGROUND

1. Field

The example implementations relate to computer systems, storage systems, and, more particularly, to storage functionalities and storage I/O performance.

2. Related Art

In the related art, a storage system may include two or more levels of storage configuration. For example, a related art storage system may include dual access from one level to data stored in another level. However, the related art storage system does not address the problems identified below.

Storage systems may need to satisfy some quality of service (QoS) or service level requirements. One requirement may be relating to data security. Another requirement may be relating to performance.

A storage system may involve two or more storage nodes and/or two or more levels of storage configuration. For example, one level of storage configuration may be virtual storage (e.g., software storage, software-defined storage, or cloud storage, collectively referred to as SW storage) that uses storage capacity of the underlying storage devices, volumes, notes, etc., which is another level of storage configuration.

Storage functionalities, such as duplication, de-duplication, compression, data migration, virus scan, etc. executing on one level of storage configuration and those executing on another level of storage configuration may cause disruption to the system or compromise system performance, which may jeopardize the QoS.

### SUMMARY

Aspects of the example implementations described herein include a first storage system that provides a first volume with an identifier to a server. The first volume is communicatively coupled to the server through a first path with a first status, which can be active or passive. There is a second storage system that provides a second volume with the same identifier to the server. The second volume is communicatively coupled to the server through a second path with a second status, which can be active or passive. The first storage system sends a first instruction to the server to change the second status from active to passive, and sends a second instruction to the second storage system to start executing a function, which accesses the second volume.

Aspects of the example implementations may involve a computer program, which responds to access from a server to a first volume with an identifier, the first volume corresponding to a storage area of the plurality of first storage devices, the first volume is configured to store data also stored in a second volume of a second storage system having a second path with a second status, which is active, and the first volume is communicatively coupled to the server through a first path with a first status, which is active; send a first instruction to the server to change the second status from active to passive; and send a second instruction to the second storage system to start executing a function, which accesses the second volume. The computer program may be in the form of instructions stored on a memory, which may be in the form computer readable storage medium as described below. Alternatively, the instructions may also be stored on a computer readable signal medium as described below.

Aspects of the example implementations may involve a system, including a server, a first storage system, and a second storage system. The first storage system provides a first volume with an identifier to a server. The first volume is communicatively coupled to the server through a first path with a first status, which can be active or passive. There is a second storage system that provides a second volume with the same identifier to the server. The second volume is communicatively coupled to the server through a second path with a second status, which can be active or passive. The first storage system sends a first instruction to the server to change the second status from active to passive and sends a second instruction to the second storage system to start executing a function, which accesses the second volume.

### BRIEF DESCRIPTION OF THE DRAWINGS

FIG. 1 illustrates an example computer system with a server in accordance with one or more example implementations.

FIG. 2 illustrates an example storage system in accordance with one or more example implementations.

FIG. 3 illustrates example storage systems and their statuses in accordance with one or more example implementations.

FIG. 4 illustrates example statuses of storage systems in accordance with one or more example implementations.

FIG. 5 illustrates example statuses of storage systems in accordance with one or more example implementations.

FIG. 6 is a detailed block diagram showing an example server program in accordance with one or more example implementations.

FIG. 7 is a detailed block diagram showing example server control information in accordance with one or more example implementations.

FIG. 8 shows an example mechanism for managing servers in accordance with one or more example implementations.

FIG. 9 is a detailed block diagram showing an example storage program in accordance with one or more example implementations.

FIG. 10 is a detailed block diagram showing example storage control information in accordance with one or more example implementations.

FIG. 11 is an example of a volume path table in accordance with one or more example implementations.

FIG. 12 is an example of a scheduler program in accordance with one or more example implementations.

FIG. 13 shows an example storage path change program and an example server path change program in accordance with one or more example implementations.

FIG. 14 illustrates an example read process in accordance with one or more example implementations.

FIG. 15 illustrates a first example write process in accordance with one or more example implementations.

FIG. 16 illustrates a second example write process in accordance with one or more example implementations.

FIG. 17 is another example of a scheduler program in accordance with one or more example implementations.

FIG. 18 illustrates a third example write process in accordance with one or more example implementations.

FIG. 19 illustrates an example of the scheduler program in accordance with one or more example implementations.

FIG. 20 illustrates a fourth example write process in accordance with one or more example implementations.

FIG. 21 illustrates another example of scheduler program and write issue program in accordance with one or more example implementations.

FIG. 22 illustrates example remote copy configuration in accordance with one or more example implementations.

FIG. 23 illustrates one more example write process in accordance with one or more example implementations.

FIG. 24 illustrates example states of storage systems in accordance with one or more example implementations.

FIG. 25 illustrates example states of storage systems in accordance with one or more example implementations.

FIG. 26 illustrates example states of storage systems in accordance with one or more example implementations.

FIG. 27 illustrates an example read process in the failure status (2) system of FIG. 26 in accordance with one or more example implementations.

### DETAILED DESCRIPTION

The following detailed description provides further details of the figures and exemplary implementations of the present application. Reference numerals and descriptions of redundant elements between figures are omitted for clarity. Terms used throughout the description are provided as examples and are not intended to be limiting. For example, use of the term “automatic” may involve fully automatic or semi-automatic implementations involving user or administrator control over certain aspects of the implementation, depending on the desired implementation of one of ordinary skill in the art practicing implementations of the present application.

### First Example Implementation

The first example implementation describes avoidance or prevention of performance decrease or degradation by using, for example, time-lag or staggering execution of storage functionalities in storage configuration (e.g., high availability storage configuration).

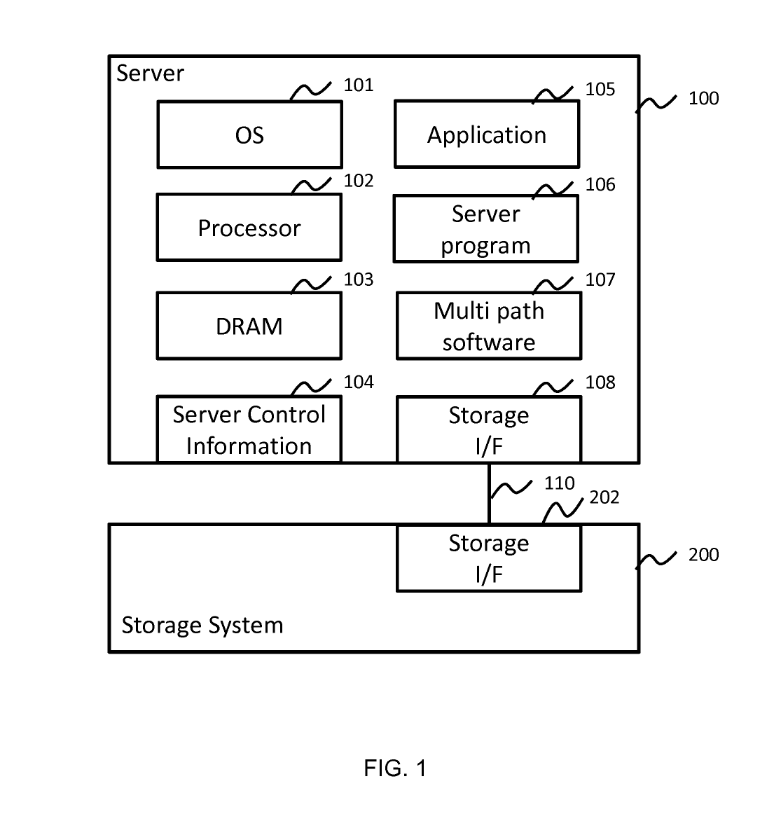

FIG. 1 illustrates an example computer system with a server in accordance with one or more example implementations. The computer system includes, for example, server 100 and storage system 200. Server 100 can be executing any operating system (OS) 101. OS 101 may be, but does not need to be, a virtual machine. Server 100 includes, for example, at least one processor 102, memory (e.g., dynamic random access memory, or DRAM) 103, and other hardware (not shown). Server 100 may be implemented to access server control information 104, one or more applications (e.g., application 105), one or more server programs 106, multipath software 107, and storage interface (I/F) 108. The server 100 provides services by executing, for example, an OS 101, application 105 (e.g., database application) and/or other applications and/or programs.

Database application 105 may access (e.g., read and write) data stored in one or more storage system 200 (one is shown). OS 101, application 105, server program 106, and multipath software 107 may be stored in a storage medium (not shown) and/or loaded into DRAM 103. The processor 102 and DRAM 103 may function together as a server controller for controlling the functions of server 100. The storage medium may take the form of a computer readable storage medium or can be replaced by a computer readable signal medium as described below. The server 100 may be communicatively coupled to the storage system 200 in any manner (e.g., via a network 110) that allows the server 100 and storage system 200 to communicate.

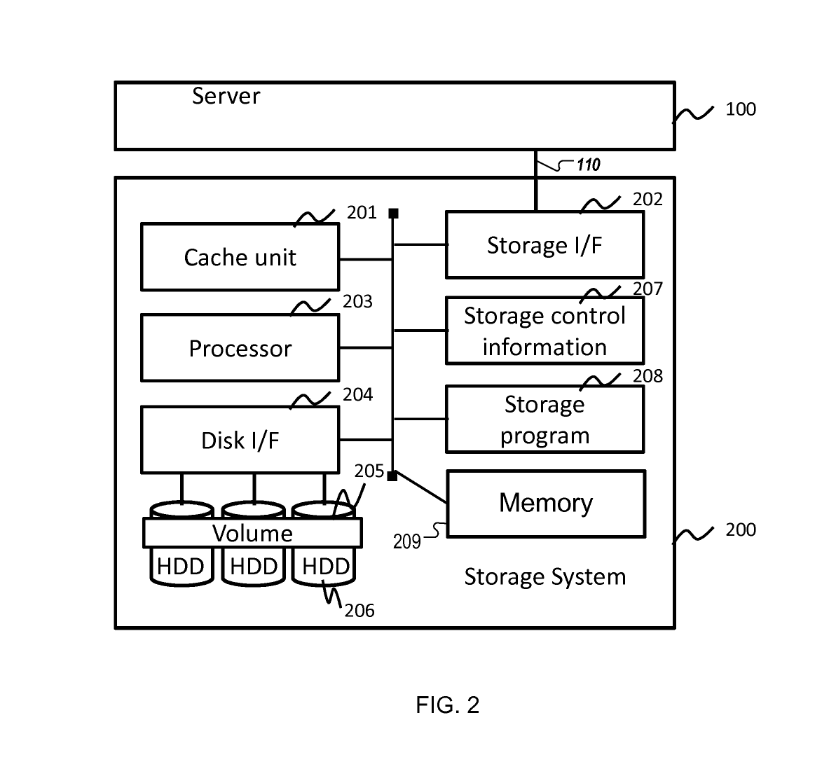

FIG. 2 shows an example storage system in accordance with one or more example implementations. Storage system 200 (e.g., enterprise storage) includes, for example, cache unit 201, at least one communication interface (e.g., storage I/F 202), at least one processor 203, disk interface (I/F) 204, at least one volume 205, at least one physical storage device 206, storage control information 207, storage program 208, and memory 209. Components 201-208 of storage system 200 are examples of components. In some implementations, a storage system may include fewer, more, or different components.

Storage I/F 202 may be used for communicating with, for example, server 100 and/or other devices and systems (not shown) via a network (not shown). The storage I/F 202 can be used for connection and communication between storage systems. Processor 203 may execute a wide variety of processes, software modules, and/or programs (collectively referred to as programs), such as read processing program, write processing program, and/or other programs. Processor 203 may execute programs stored in storage program 208 and/or retrieved from other storages (e.g., storage medium, not shown).

The above described programs (e.g., storage program 208), other software programs (e.g., one or more operating systems), and information (e.g., storage control information 207) may be stored in memory 209 and/or a storage medium. A storage medium may be in a form of a computer readable storage medium, which includes tangible media such as flash memory, random access memory (RAM), hard disk drive (HDD), SSD, or the like. Alternatively, a computer readable signal medium (not shown) can be used, which can be in the form of carrier waves. The memory 209 and the processor 203 may work in tandem with other components (e.g., hardware elements and/or software elements) to function as a controller for the management of storage system 200.

Processor 203, programs (e.g., storage program 208), and/or other services accesses a wide variety of information, including information stored in storage control information 207. Disk I/F 204 is communicatively coupled (e.g., via a bus and/or network connection) to at least one physical storage device 206, which may be a HDD, a solid state drive (SSD), a hybrid SSD, digital versatile disc (DVD), and/or other physical storage device (collectively referred to as HDD 206). In some implementations, cache unit 201 may be used to cache data stored in HDD 206 for performance boost.

In some implementations, at least one HDD 206 can be used in a parity group. HDD 206 may be used to implement high reliability storage using, for example, redundant arrays of independent disks (RAID) techniques. At least one volume 205 may be formed or configured to manage and/or store data using, for example, at least one storage region of one or more HDD 206.

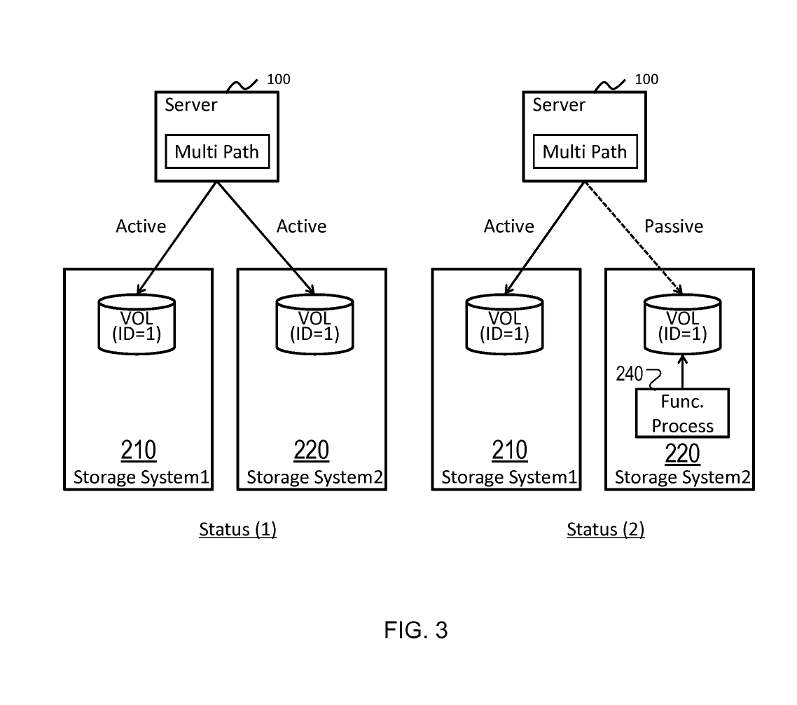

FIGS. 3-5 illustrate an example system in different stages with different statuses in accordance with one or more example implementations. The example system includes a server 100 and two or more storage systems 210 and 220.

FIG. 3 illustrates example storage systems and their statuses in accordance with one or more example implementations. A server 100 may be communicatively connected to two or more storage systems 210 and 220 (e.g., server 100 has paths to storage system 210 and 220 to issue read/write or input/output (I/O) requests or commands). Storage systems 210 and 220 are communicatively coupled to each other. Storage systems 210 and 220 may be in high availability (HA) storage configuration.

In a HA storage configuration, two or more volumes or storage systems (e.g., storage systems 210 and 220) may be providing concurrent data access, fault tolerant protection, data security, and other performance and/or security related services by configuration/deploying duplicate volumes. Each storage systems 210 and 220 (and other storage systems if configured to be access by server 100) may be assigned the same volume identifier (e.g., ID=1). When server 100 access data of a volume (e.g., with ID=1), server 100 may issue read/write commands to any storage volume or system with volume ID=1 (e.g., storage system 210 or 220). When the command is a write command, the storage system (e.g., storage system 210) that services the write command replicates the write data to the other volume or storage system (e.g., storage system 220). Therefore, the data stored in two volumes (in storage systems 210 and 220) is synchronized. If one of the storage systems 210 and 220 fails, storage services to server 100 are not disrupted.

A storage system (e.g., storage systems 210 and/or 220) may provide functionalities, such as duplication function, local copy function, remote copy function, de-duplication function, compression function, data migration function, virus scan function, etc. In order to prevent performance decrease or degradation, functions that are not involved with servicing read/write or I/O requests are isolated as much as possible from the execution of read/write or I/O requests.

In FIG. 3, the example system with status (1) (or the status (1) system) shows that both paths server 100 is communicatively connected to storage systems 1 and 2 are active. Server 100 may access storage volume with volume ID=1 in either or both storage systems 1 and 2 via the active paths (may be referred to as I/O paths). No storage functionalities are active in the status (1) system.

A “storage functionality” or “functionality” associated with a storage volume, as used herein, refers to any program, process, function, operation, series of operations, etc. that are executed in association with any data stored in the storage volume. A “storage functionality” or “functionality” is not a read/write or I/O request from a server.

In the status (2) system, storage functionality 240 is being applied to a storage volume in storage system 220. Before or during the execution of storage functionality 240, I/O path to storage system 220 may be changed to the passive status. While in passive status, server 100 issues I/O requests to a storage system with an I/O path with an active status (e.g., storage system 210). Since no storage functionality is being executed concurrently with servicing the I/O requests from server 100, the performance of storage system 210 is not affected (e.g., not decrease due to the execution of storage functionality 240).

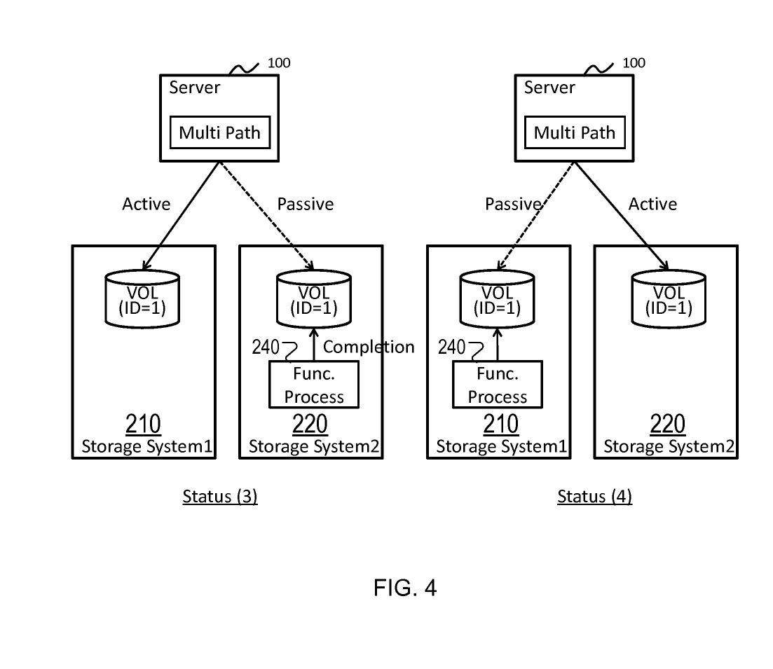

In FIG. 4, status (3) system shows that storage functionality 240 has reached completion. Storage functionality 240 may be one that needs to be executed on storage system 210 (e.g., to keep data in the volumes with the same ID synchronized, etc.). Before executing storage functionality 240 in storage system 210, the I/O path to storage systems 210 is changed (e.g., by server 100, storage system 210, or storage system 220) to a passive status and the I/O path storage system 220 is changed to an active status.

In the status (4) system, the storage functionality 240 is applied to a storage volume in storage system 210. While in passive status, server 100 issues I/O requests to a storage system with an I/O path with an active status (e.g., storage system 210).

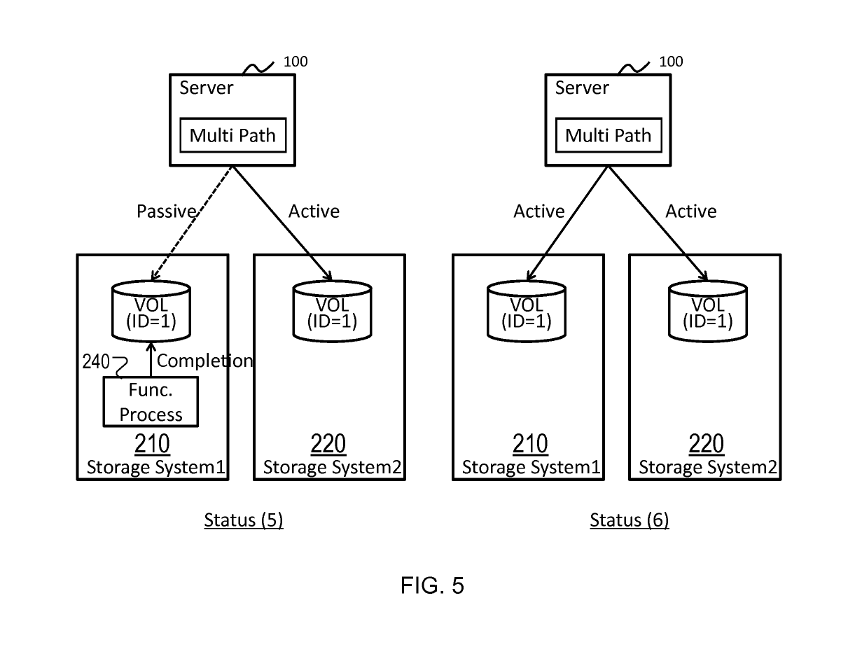

In FIG. 5, status (5) system shows that storage functionality 240 has reached completion. The I/O path to storage systems 210 may be changed (e.g., by server 100, storage system 210, or storage system 220) to an active status. The status (6) system shows that the I/O path to the storage system 210 has been changed to and active status. As with the status (1) system, the statuses of the I/O paths to both storage systems 210 and 220 are active.

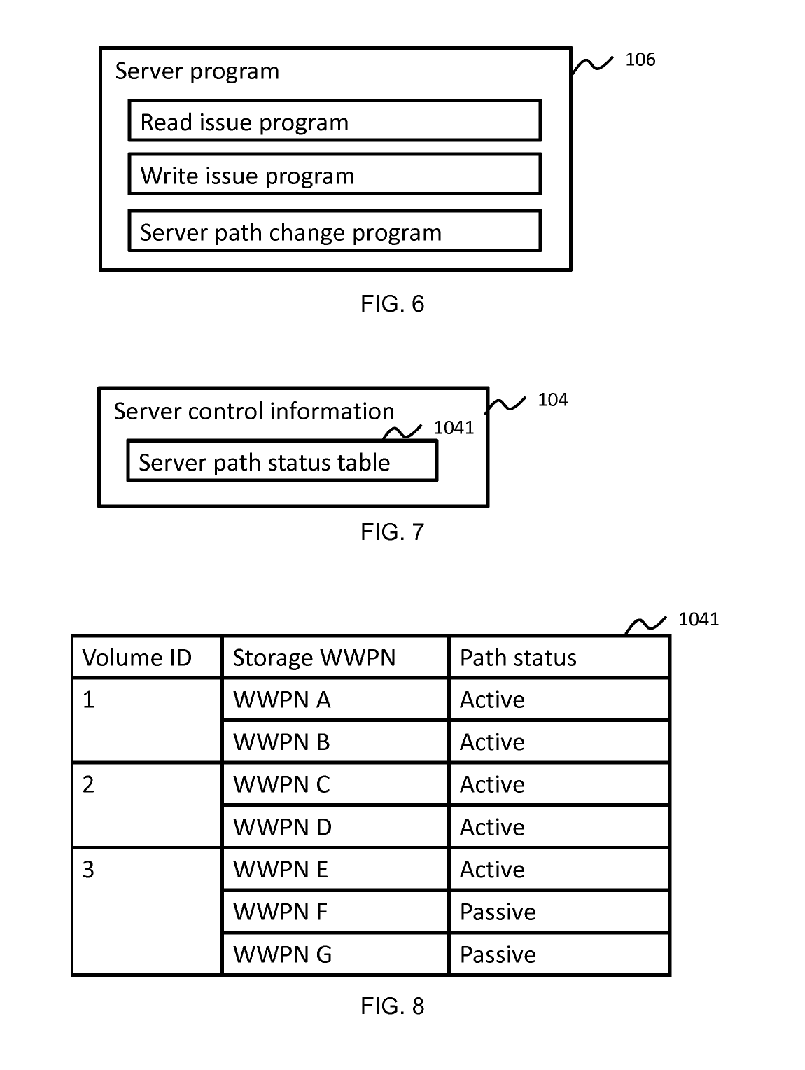

FIG. 6 is a detailed block diagram showing an example server program in accordance with one or more example implementations. Server program 106 includes, for example, a read issue program, a write issue program, and server path change program. These example programs are described below. There may be other programs (not shown) executed by server 100.

FIG. 7 is a detailed block diagram showing example server control information in accordance with one or more example implementations. Server control information 104 includes, for example, server path status table 1041, described in FIG. 8 below. There may be other information and/or tables (not shown) used by server 100.

FIG. 8 shows an example mechanism for managing storage access in accordance with one or more example implementations. Server path status table 1041 includes, for example, a column for storing volume ID, a column for storing port identifier (e.g., worldwide port name, or WWPN), a column for storing the status of the WWPN, and other information (not shown). The volume ID is an identifier for identifying a volume in the system. The volume ID may identify an actual volume or a virtual volume. The storage WWPN is a unique port identifier (e.g., port name) used to access the storage volume with the corresponding volume ID. The path status manages the status of the path (e.g., active, passive, and other status not shown). An active status indicates that the corresponding WWPN can be used to access the storage volume with the corresponding volume ID (e.g., the storage volume with the corresponding volume ID is online and available). A passive indicates that the storage volume with the corresponding volume ID is offline and not available (i.e., the corresponding WWPN cannot be used to access the storage volume with the corresponding volume ID).

In the example of the server path status table 1041, the storage volume with volume ID=1 can be accessed via WWPN A and WWPN B, both of which are active; the storage volume with volume ID=2 can be accessed via WWPN C and WWPN D, both of which are active; and the storage volume with volume ID=3 can be accessed via WWPN E only, for it is the only active port or path. WWPN F and WWPN G, the other paths to access the storage volume with volume ID=3, are passive.

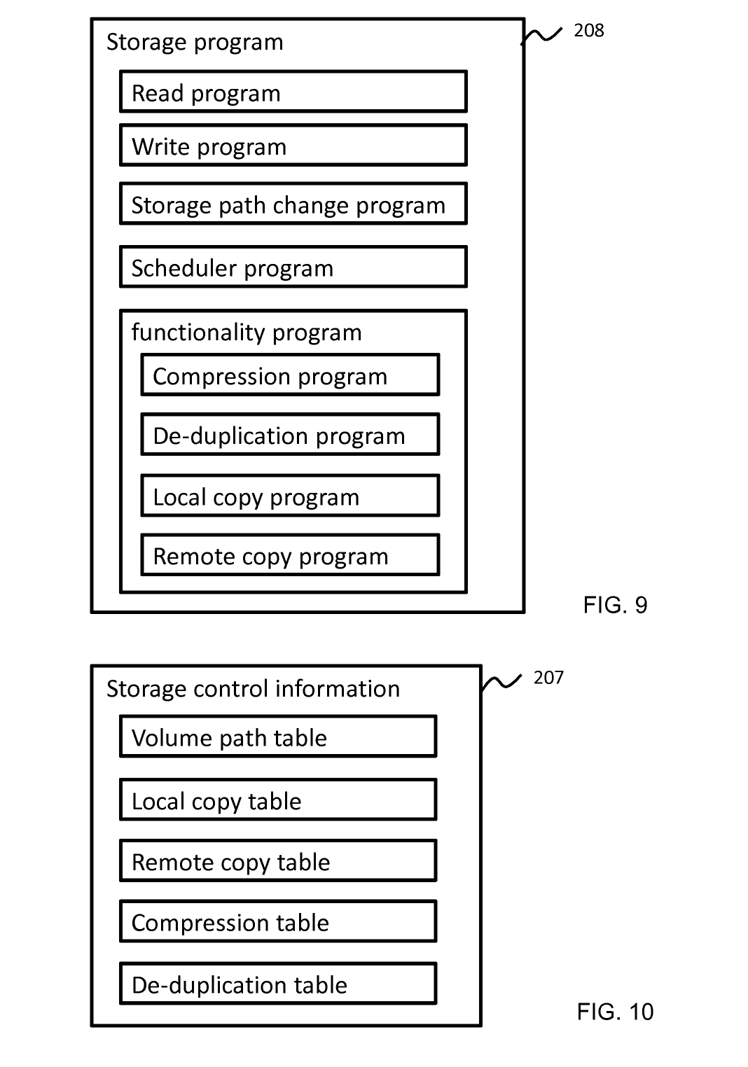

FIG. 9 is a detailed block diagram showing an example storage program in accordance with one or more example implementations. Storage program 208 includes, for example, a read program, a write program, a storage path change program, a scheduler program, a compression program, a de-duplication program, a local copy program, and a remote copy program. The compression program, de-duplication program, local copy program, and remote copy program are example programs of storage functionalities. The programs shown in storage program 208 and described further below are example programs and are not limited to the programs shown. Other programs may be executed.

FIG. 10 is a detailed block diagram showing example storage control information in accordance with one or more example implementations. Storage control information 207 includes, for example, volume path information or table, local copy information or table, remote copy information or table, compression information or table, and/or de-duplication information or table, etc. Storage control information 207 may include a table used to manage the path information between storage systems (not shown). The various tables are shown as example only and are not limited to using tables to store information, which can be stored in any format or mechanism (e.g., database, files, lists, etc.).

The local copy table may be used to manage relationships between source volume and destination volume, copy status, etc. In addition to information managed in the local copy table, the remote copy table may be used to manage relationships between source storage system and destination storage system, including path information between storage systems, for example.

The compression table may be used to manage the information about volume, including, for example, the compression algorithm(s) being applied to the given volume, compression rate, etc. In some implementations, if one or more post-process compressions are used with a volume, the amount of the uncompressed data may be managed. A post-process compression means that the compression process is asynchronously executed with I/O processing.

The de-duplication table may be used to manage the information about volumes to which a de-duplication functionality is applied. The de-duplication information or table may include volume address, hash value corresponding to the data stored in the area specified by the volume address, a pointer to an area where data is actually stored, etc.

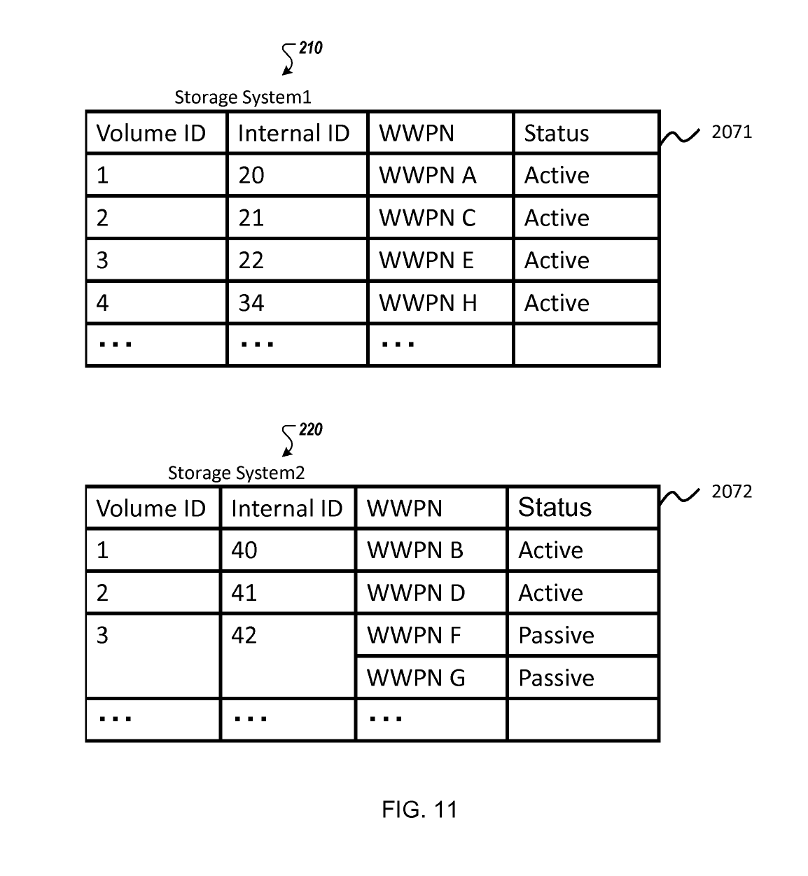

FIG. 11 is an example of a volume path table in accordance with one or more example implementations. The volume path table 2071 is an example used by and/or stored in storage system 210 and the volume path table 2072 is an example used by and/or stored in storage system 220.

Tables 2071 and 2072 include, for example, columns for volume ID, internal ID, WWPN, and status. There may be other information (e.g., stored in other columns, not shown). The volume ID, WWPN, and status columns store the same or similar information as stored in the equivalent columns of table 1041, FIG. 8.

The internal ID column stores identifiers for identifying storage volumes in the storage system (e.g., storage system 210 or 220).

In the example of FIG. 11, the same data are stored in at least a portion of volume 1, which resides in both storage system 210 and storage system 220. The same data is stored and/or provided in two or more locations for high availability, security, and/or other purposes. Write data to the volume 1 is replicated between these storage systems 210 and 220. Tables 2071 and 2072 show volume 1 may be accessed (e.g., by one or more authorized servers, e.g., server 100) using two paths—WWPN A and WWPN B. Path WWPN A is connected to the storage system 210 and path WWPN B is connected to the storage system 220.

Tables 2071 and 2072 show, for example, that storage systems 210 and 220 also provide storage volume 2. Storage system 210 and 220 are shown providing storage volume 3 with three access paths—WWPN E to storage system 210 and WWPN F and G to storage system 220. In addition, storage system 210 provides storage volume 4, which may be an un-mirrored volume or a mirrored volume 4 may be provided by another storage system (not shown).

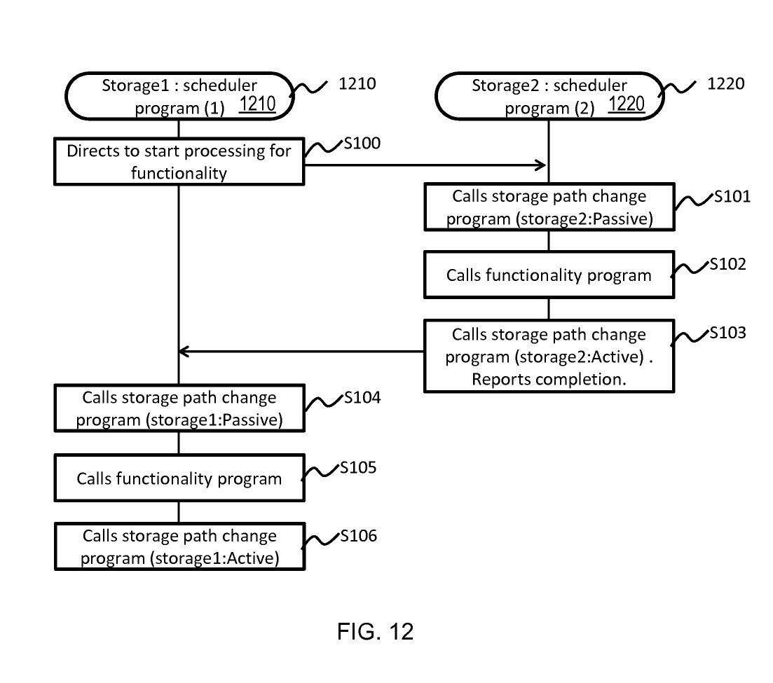

FIG. 12 is an example of a scheduler program in accordance with one or more example implementations. Scheduler program 1210 may be executed in storage system 210 (labeled as Storage1), and scheduler program 1220 may be executed in storage system 220 (labeled as Storage2). Scheduler programs 1210 and 1220 may be the same scheduler program or two different scheduler programs.

A storage system (e.g., storage system 210) may execute a scheduler program to manage access paths to that storage system and another storage system 220 with respect to a storage volume provided by both storage systems 210 and 220. Scheduler programs may be executed to change the path status (e.g., to enable time-lag execution of storage functionalities).

At S100, scheduler program 1210 directs storage system 220 (e.g., via scheduler program 1220) to start a storage functionality, such as data compression, data copy, data migration, data de-duplication, etc. The storage system 220, which may be executing scheduler program 1220, receives the direction from the storage system 210.

Before a storage functionality is executed, scheduler program 1220, executed in storage system 220, calls a storage path change program, for example, to change the multipath status (e.g., WWPN B of table 2072, FIG. 11). To execute the storage functionality in storage system 220, in S101, path WWPN B is brought offline (e.g., to the passive status). To ensure that volume 1 remains available when storage system 220 is brought offline, storage system 220 may request the status of the path (e.g., WWPN A) in storage system 210. The storage system 210 may notify the status of the path (e.g., WWPN A) in storage system 210 to the storage system 220. If the path status of the storage system 210 is passive, the storage system 220 does not change the status of the path (e.g., WWPN B) in storage system 220 (i.e., does not bring storage system 220 offline until storage system 210 notifies storage system 220 that the path to storage system 210 has become active).

Storage system 220 then calls a functionality program corresponding to the storage functionality at S102. When the execution completes or finishes at S102 storage system 220 calls a storage path change program to change the path status in the storage system 220 (e.g., WWPN B) to active and notifies storage system 210 of the completion status of the storage functionality at S103.

If the storage functionality needs to be performed on storage system 210, before performing the storage functionality, storage system 210 calls a storage path change program, for example, to change the multipath status (e.g., WWPN A of table 2071, FIG. 11). At S104, the path to the storage system 210 is changed to passive.

At S105, storage system 210 (e.g., via scheduler program 1210) then starts performing the storage functionality (e.g., calls a functionality program corresponding to the storage functionality). When the execution completes or finishes, storage system 210 calls a storage path change program to change the path status in storage system 210 (e.g., WWPN A) to active at S106.

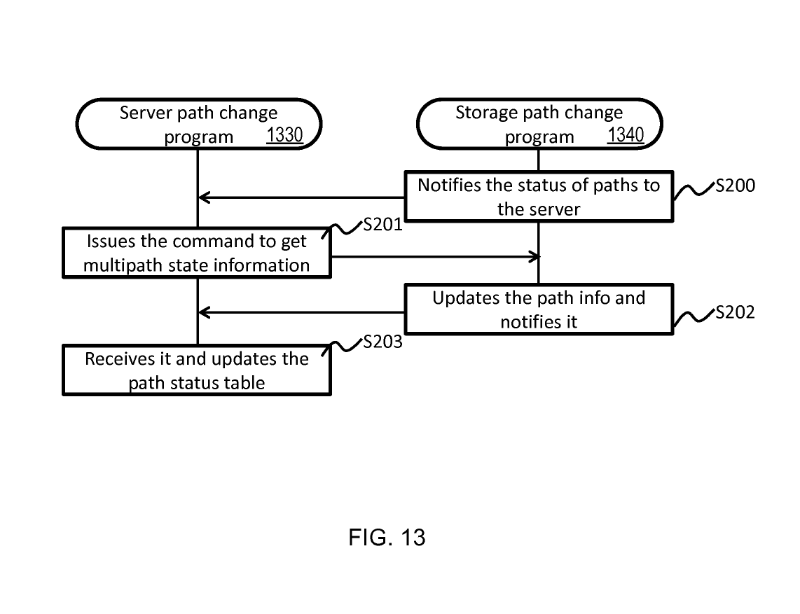

FIG. 13 shows an example storage path change program and an example server path change program in accordance with one or more example implementations. A server (e.g., server 100) executes the server path change program 1330. One or more storage systems (e.g., storage systems 210 and 220) execute or call the storage path change program 1340. At 5200, the storage path change program 1340, which is called from, for example, the operations at S101, S103, S104, and S106, FIG. 12, notifies or provides the status of the paths to the server. In some implementations, a server is implemented to check or confirm the multipath status at 5201 (e.g., by issuing a status request command to the storage system executing the storage path change program 1340). The storage path change program 1340 updates the volume path information (e.g., table 2071 or 2072, FIG. 11), if not already updated, and notifies the updated path status to the server at 5202. The server path change program 1330 receives and updates the path status information (e.g., table 1041, FIG. 8) in the server.

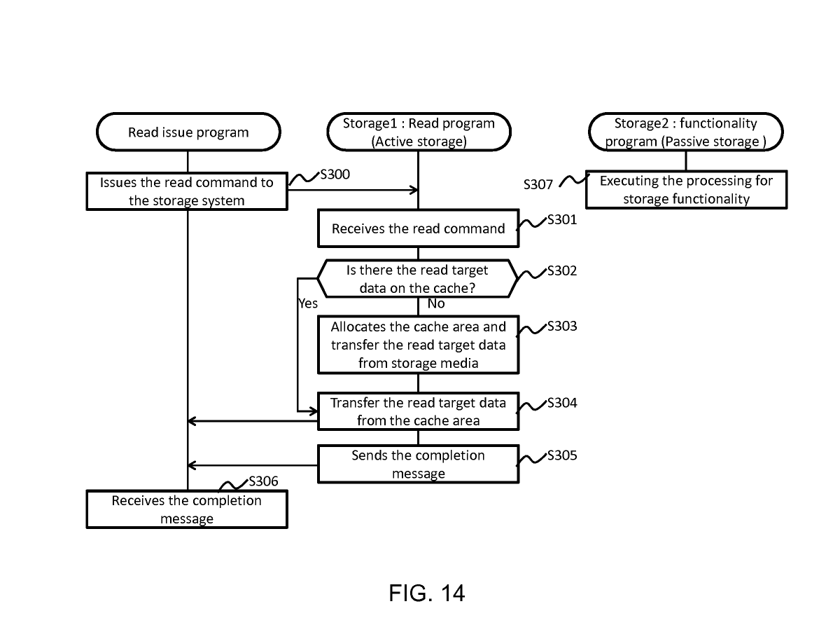

FIG. 14 illustrates an example read process in accordance with one or more example implementations. The read process may be performed in an example system, such as the status (2) system of FIG. 3, where a read issue program executed in server 100 issues a read command, at S300, to storage system 210 via an active path, when storage system 220, with a passive access path, is performing or applying storage functionality 240 at S307.

In this example, the storage system 210 receives the read command at S301. At S302, storage system 210 (e.g., executing a read program) determines whether the read target data has previously read and cached (e.g., whether the data requested in the read command is already cached in cache unit 201). If the data is not in the cache, the read program allocates a cache area and reads or transfers the read target data from, for example, HDD to the allocated cache area at S303. At S304, if the data is in the cache, from S302 or S303, the data is transferred, or provided, or returned from the cache area to the requester (e.g., the read issue program at server 100). In some implementations, for example, when a read request is returned in more than one response, read program in storage system 210 sends, at S305, a completion message or status to the read issue program, which is received at S306.

Note that the storage system 210, the system with an active path, receives the read command and services the read command. Since the storage functionality is performed by the storage system 220 and not by the storage system 210 when it is also servicing the read command, system performance at storage system 210 is not negatively affected.

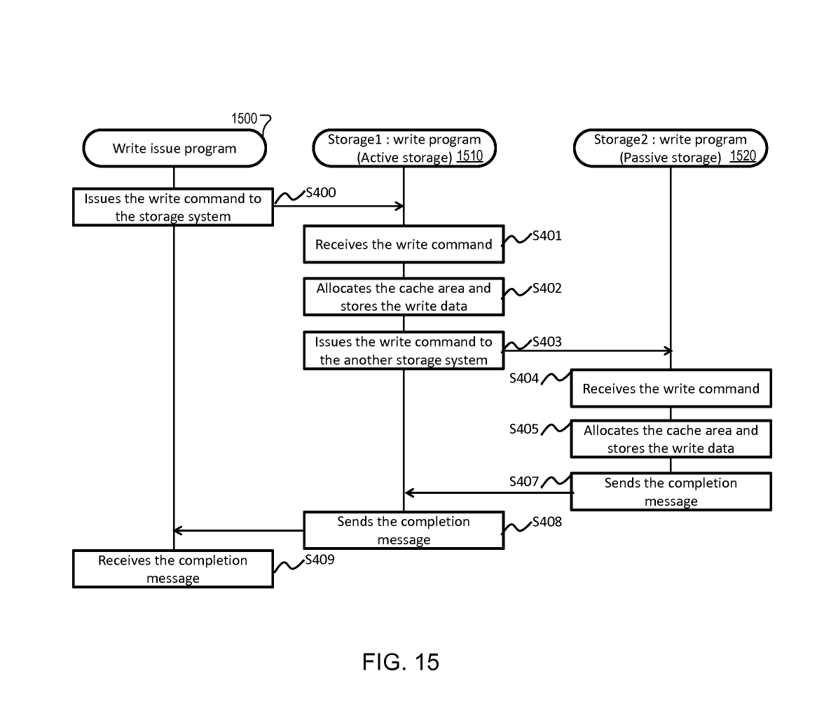

FIG. 15 illustrates a first example write process in accordance with one or more example implementations. In this example write process, write data is written to both storage systems 210 and 220. This example write process may be performed in an example system, such as the status (2) system of FIG. 3, where the path to storage system 210 is active and the path to storage system 220 is passive.

At S400, a write issue program 1500 (e.g., executing on server 100) issues a write command to storage system 210. The storage system 210 (e.g., via a write program 1510) receives the write command at S401. In some implementations, the write program 1510 allocates a cache area and stores the write data to the cache (e.g., in cache unit 201, FIG. 2) at S402. At S403, the write program 1510 issues a write command with the write data to the storage system 220, which may be executing write program 1520.

Storage system 210 then waits for a response from the storage system 220. The storage system 220 (e.g., via a write program 1520) receives the write command at S404. In some implementations, the write program 1520 allocates a cache area and stores the write data to the cache at S405.

At S407, storage system 220 sends a completion message or status to storage system 210. After receiving the completion message, which indicates that the write data is written in storage system 220, at S408, storage system 210 sends a completion message or status to storage server 100, which is received at S409.

Note that even when all I/O paths to storage system 220 are offline, write data is sent to the storage system to maintain data synchronization (e.g., in volume 1).

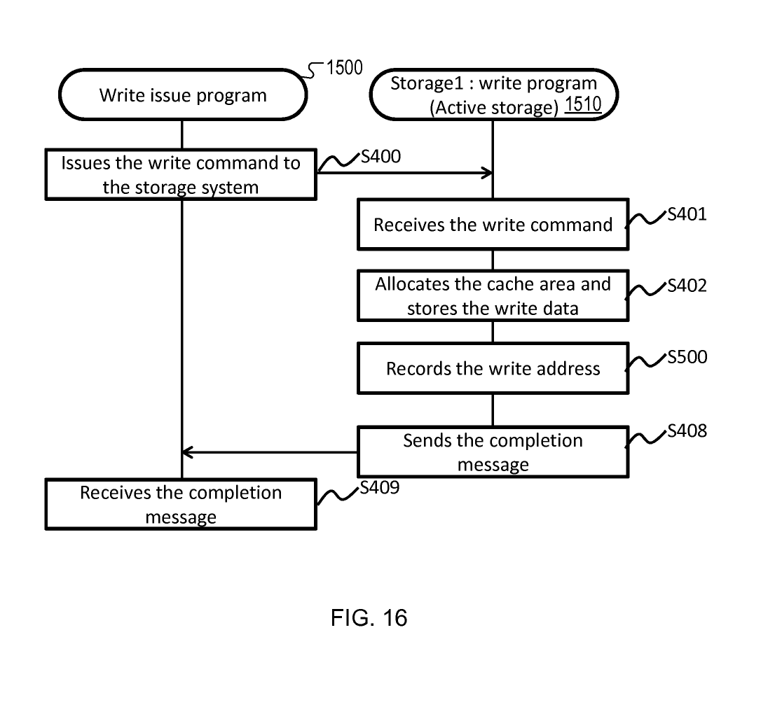

FIG. 16 illustrates a second example write process in accordance with one or more example implementations. The second example write process is the same as the first example write process, FIG. 15, with respect to the operations at S400-S402 and S408-S409. The operations at S403-S405 and S407 are replaced with the operations at S500.

After the operations at S402, storage system 210 records the write address and write data at S500. After completion of storage functionality execution in storage system 220, storage system 210 transfers the write address and write data to storage system 220 at some point to synchronize the data stored in storage systems 210 and 220. In some implementations, storage system 210 may transfer the write address and write data to storage system 220 when storage system 220 is ready to receive the write data.

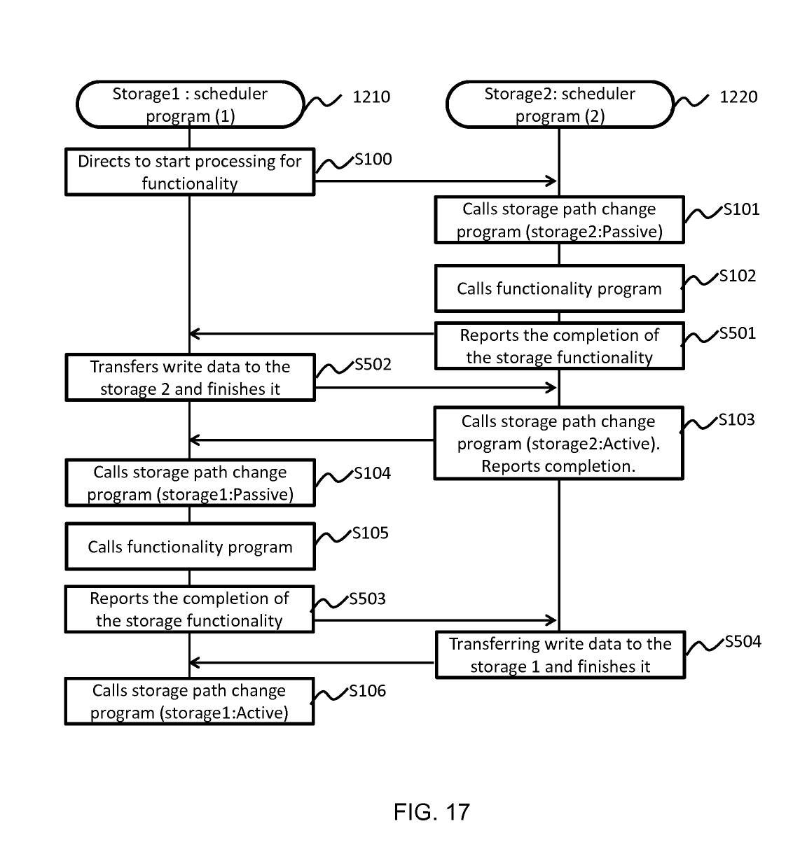

FIG. 17 is another example of a scheduler program in accordance with one or more example implementations. The example process may be implemented using scheduler programs 1210 and 1220, described in FIG. 12. The operations at S100-S106 are described in FIG. 12.

In the example of FIG. 16, storage system 210 has recorded write address, at S500, to be synchronized with storage system 220, which may be performing a storage functionality at S102, FIG. 17, and not ready to receive the write data. The storage system 220, at S501, sends the completion message to the storage system 210 after finishing the storage functionality at S102. When storage system 210 receives the completion status of the storage functionality from storage system 220 at S501, which indicates that storage system 220 is ready to receive the write data, storage system 210 transfers the write data to storage system 220 at S502.

At S502, the storage system 210 read the data from storage area specified by recorded address in storage system 210 and transfers it to storage system 220. The storage system 220 which receives the write data executes the write operations that are the same or similar to the operations of S404, S405, and S407, described in FIG. 15.

After completion of S502, the storage system 220 changes the path status to the active because the data in the storage system 220 is synchronized.

If, for example, a write command is issues to storage system 220 after storage system 220 changed the path status to the active at S103, storage system 220 may record write address (e.g., write operation is same as the FIG. 16, with the active storage being storage system 220) to be synchronized with storage system 210. When storage system 220 receives the completion status of the storage functionality from storage system 210 at S503, which indicates that storage system 210 is ready to receive the write data, storage system 220 transfers the write data to storage system 210 at S504.

The storage system 210 which receives the write data executes the write operations that are the same or similar to the operations of S404, S405, and S407, described in FIG. 15.

With the second example write process, the write data is not replicated between storage systems (e.g., 210 or 220) when the system is performing a storage functionality. If the storage system that is not performing a storage functionality (e.g., the storage system that has recorded write address) experiences a system or volume failure that affect the data to be synchronized, a recovery process may be instituted to recover the write data. For example, a database recovery process, such as a redo/undo operation from an audit trail, a rollback, or another recover operation.

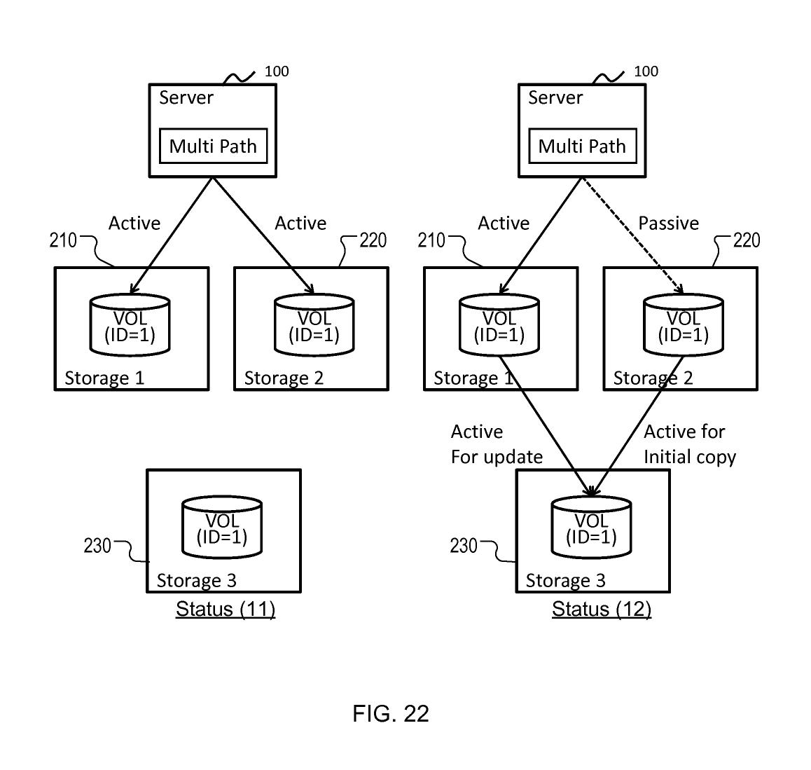

In some implementations, e.g., in a HA storage configuration, three or more storage systems may be deployed (FIG. 22, described below). With a third storage volume or system, write data held by a storage system to be synchronized may be replicated to the third storage system. The third storage system may provide a second copy of the write data if and when needed (e.g., when the described failure occurs).

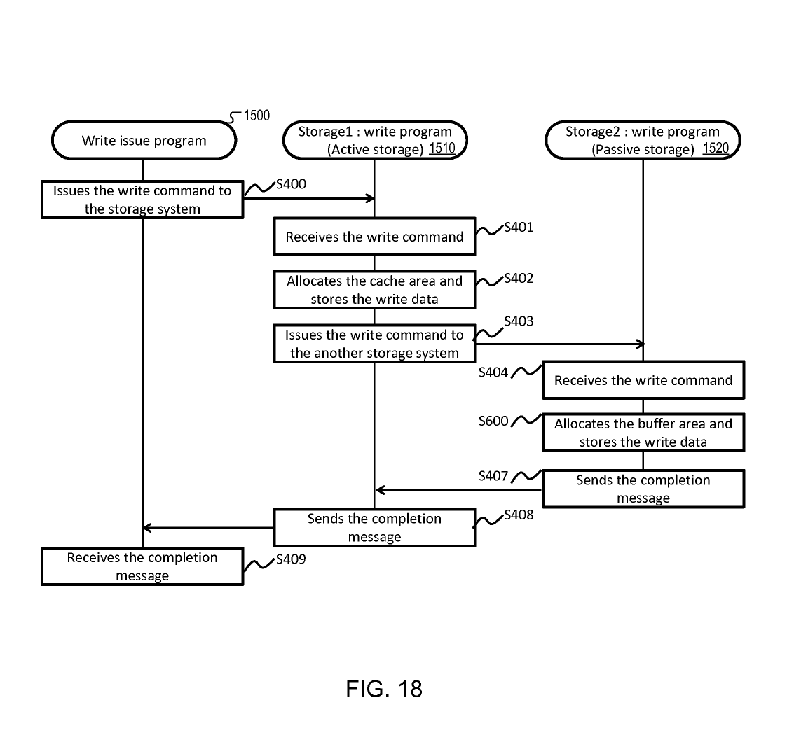

FIG. 18 illustrates a third example write process in accordance with one or more example implementations. The third example write process is the same as the first example write process with respect to the operations at S400-S404 and S407-S409. The operations at S405 are replaced with the operations at S600. At S600, the write data is temporally stored in a buffer area without storing or writing to a volume (e.g., in volume 1 hosted at storage system 220). Storing the write data to a buffer avoids accessing a volume to store the write data, which avoids consumption of storage resources, avoids lock competition, and avoids performance decrease.

A sequence number can be assigned to the write data. The data can be stored as journal data by using the sequence number.

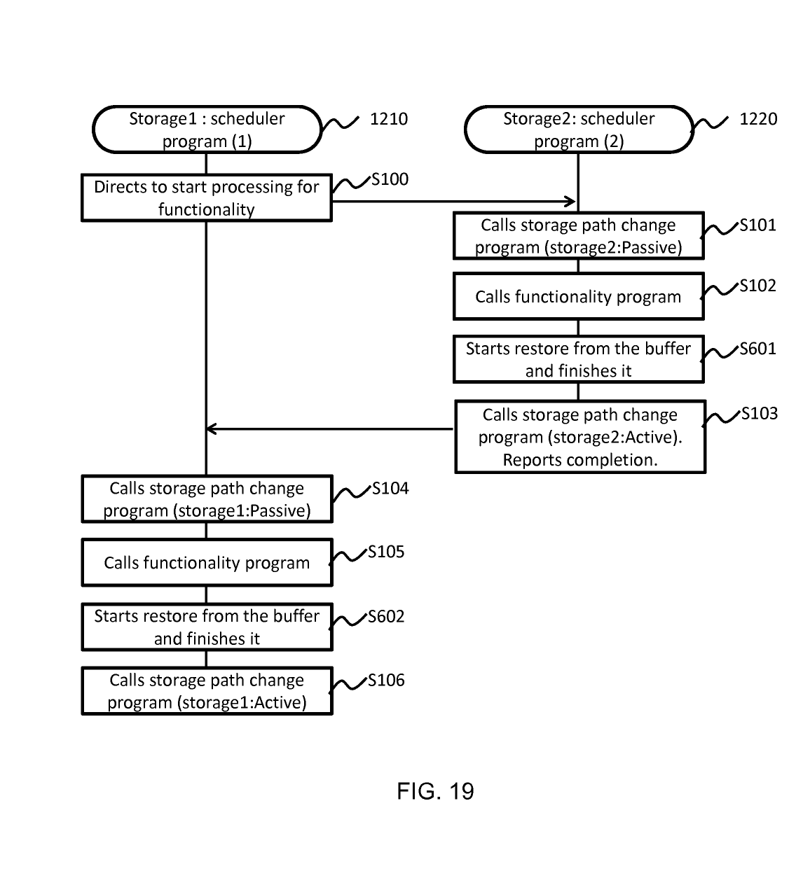

FIG. 19 illustrates another example of the scheduler program in accordance with one or more example implementations. To eventually store the write data saved in the buffer to a volume, a scheduler program may be used to synchronize the write data. The example synchronization process may be implemented using scheduler programs 1210 and 1220, described in FIG. 12. The operations at S100-S106 are described in FIG. 12.

At an appropriate time in the scheduler process, data stored in a buffer may be restored (i.e., transferred from the buffer to a volume).

In the storage system 220 (Storage2), the scheduler program 1220 starts a restore process at S601 after finishing the storage functionality at S102. The scheduler program 1220, at S103, calls the storage path change program to change the path status of the storage system 220 to the active and sends the completion message to storage system 210 after finishing the restore processing.

The scheduler program 1210 that received the completion message from the S103 executes the operations at S104 and S105. Storage system 210 starts a restore process at S602 after finishing the storage functionality at S105. The data restored may be received while the storage system 210 was performing the storage functionality.

The storage system 210 calls the storage path change program to change the path status of the storage system 210 to the active at S105.

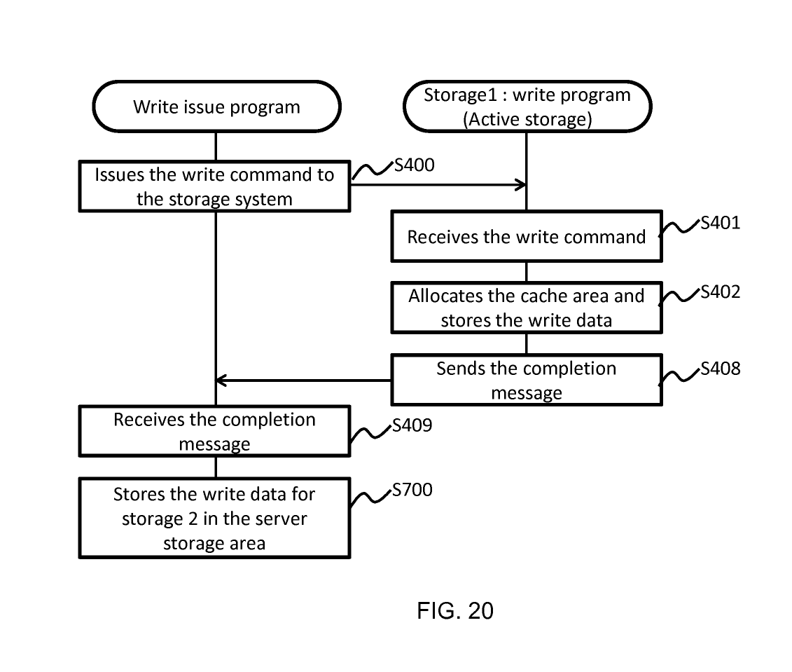

FIG. 20 illustrates a forth example write process in accordance with one or more example implementations. In this example write process, a server may have storage area to store the cached data or temporary data. The storage area may consist of flash memory or other memory with similar properties to store the write data into the storage area. The example write process is the same as the first example write process with respect to the operations at S400-S402 and S408-S409.

The storage system which receives the write command from the server (e.g., Storage1 or storage system 210) does not issue the write command to the storage system 220 (i.e., there are no operations similar to those at S403-S405 and S407).

After receiving the completion message from the storage system 210 at S409, at S700, the server stores the write data for storage system 220 in the server storage area.

A sequence number can be assigned to the write data. The data can be stored as journal data by using the sequence number.

The data can be managed by write address and data instead of the journal data. If the write command is issued to the same address, the write data is overwritten. To do so, the total size of the data in the server storage area can be reduced.

The write data stored in the server storage area is subsequently written to a storage system (e.g., storage system 220).

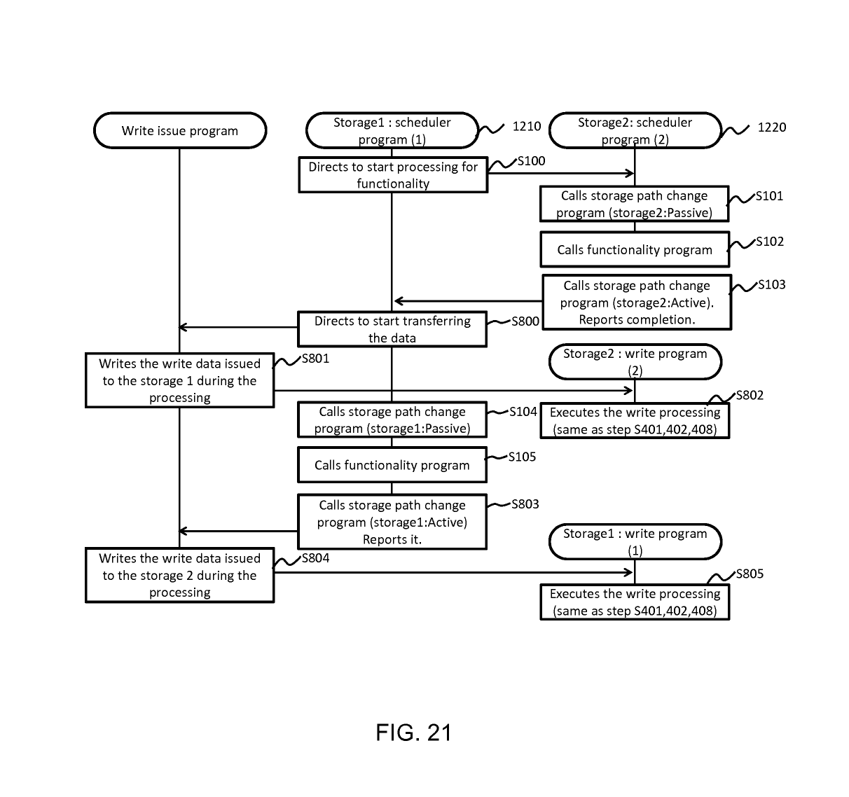

FIG. 21 illustrates another example of scheduler program and write issue program in accordance with one or more example implementations. This example write process writes or transfers the write data from the server storage area to a storage system. The example write process may be implemented using scheduler programs 1210 and 1220, described in FIG. 12. The operations at S100-S105 are described in FIG. 12.

After receiving the completion message of the storage functionality in the storage system 220 (Storage2), at S103, the storage system 210 (Storage1) notifies the completion of the storage functionality to the server at S800. The storage system 220 (Storage2) may send the completion message to the server directly. After changing the path status to active at S103, storage system 220 is ready to receive the write command from S801.

Then, at S801, the server sends to storage system 220 the write data, which has been written to the storage system 210 and stored in the server storage area but not written to storage system 220. Storage system 220 may be performing a storage functionality at the time the write data was written to storage system 210. At S802, the storage system 220 which receives the write data executes write operations similar to or the same as those of S404, S405 and S407, described in FIG. 15.

The data stored in the storage system 220 may not be up to date before S802, for example, when the data stored in the server storage area are being synchronized. Therefore, the data stored in the storage system 220 cannot be used to service I/O from the server. If the storage system 220 receives a read command before data synchronization at S802, the read command may be serviced from storage system 210, e.g., reading the requested data from the storage system 210 and transferring it to the server. When the server issues a new write command data synchronization at S802, the server check whether the data with same address is stored in the server storage area or not. If the data is stored in the server storage area (data to be synchronized), the new write data is overwritten to the server storage area. If the data is not stored in the server storage area, the new write data is written to the storage system 220 directly. After finishing data synchronization at S802, read and write commands are processed normally (e.g., directly by storage system 220 if in active status).

If server issues a write command when storage system 210 is performing the operations at S104 (i.e., the path to storage system 210 is passive), the write command is serviced by storage system 220. The write data has been written to the storage system 220 and stored in the server storage area but not written to storage system 210. After storage system 210 finishes the storage functionality at S105, storage system 210 changes the path status of the storage system 210 to active and notifies the completion of the storage functionality to the server at S803.

Then, at S804, the server sends to storage system 210 the write data, which has been written to the storage system 220 and stored in the server storage area but not written to storage system 210. At S805, the storage system 210 which receives the write data executes write operations similar to or the same as those of S404, S405 and S407, described in FIG. 15.

### Second Example Implementation

The second example implementation illustrates and describes remote copy of data being applied to the first example implementation. FIGS. 1-21 relating to the first example implementation are applicable in the second example implementation.

FIG. 22 illustrates example remote copy configuration in accordance with one or more example implementations. In a second example implementation, remote copying configuration and features are described. In a configuration that includes remote copying, if the data of the storage system 210 or 220 is copied to the one or more remote volumes, storage system 210 or 220 can be managed as described above to avoid performance decrease. The status (11) is an initial status before applying the remote copy. The status (11) system is the same as the status (1) system in FIG. 3 or the status (6) system in FIG. 5 with the addition of a storage system 230 (Storage 3). All three storage systems 210, 220, and 230 has a volume 1 (a volume with the ID=1).

The status (12) system shows that a remote copy functionality is applied to volume 1. After the remote copy functionality, the storage system 210 and/or 220 copies all data stored in the source volume 210 and/or 220 to the destination volume 230.

To ensure performance (i.e., prevent performance decrease) a remote copy functionality is a storage functionality, which is performed only to the storage system with a passive access path. For example, in the status (12) system, the storage system 210, with an active path from server 100, services the I/O commands from the server 100. The storage system 220, with a passive path from server 100, initially copies the data from the source volume (volume 1 of storage system 220) to the destination volume (volume 1 of storage system 230). When the storage system 210 receives a write command from the server 100, the storage system 210 transfers it to the storage system 230.

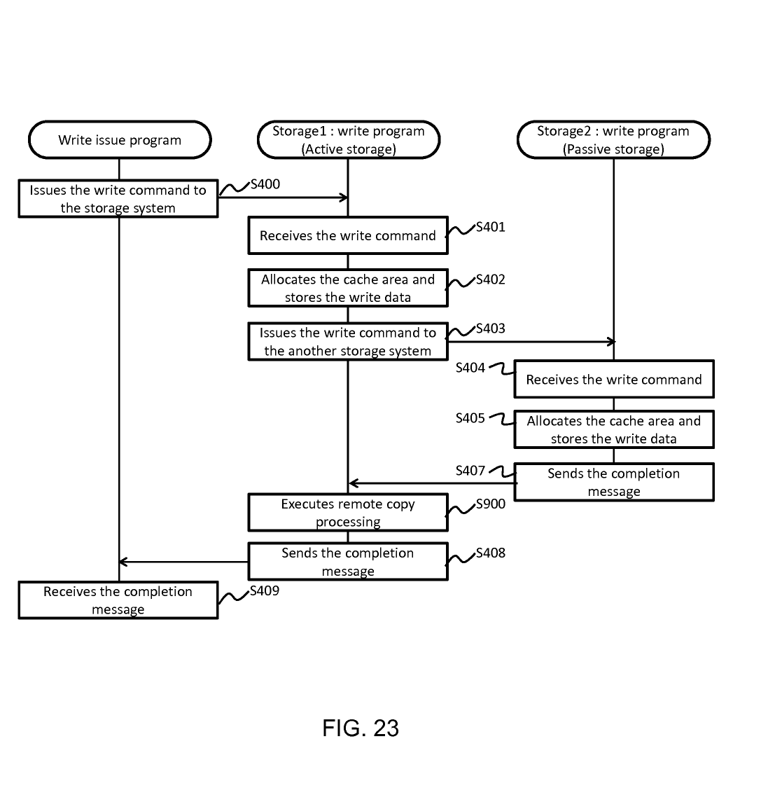

FIG. 23 illustrates one more example write process in accordance with one or more example implementations. This example write process is the same as the first example write process described in FIG. 15 with respect to the operations at S400-S406 and S408-S409. In addition, storage system 210 (Storage1), after receiving the completion message at S407 from storage system 220 and before sending a completion message at S408 to the server, executes a remote copy application or operation at S900 to copy the write data to a remote storage system (e.g., storage system 230).

If the remote copy operation is synchronous, the storage system 210 issues a write command to the storage system 230 (the remote storage system). If the remote copy operation is asynchronous, the storage system 210 makes journal data and stores it in a buffer area or another storage mechanism at storage system 210. The storage system 210 then transfers the write data to the storage system 230 subsequently. In some implementations, the operations at S900 can be executed after S408, such as in a semi-synchronous remote copy operation.

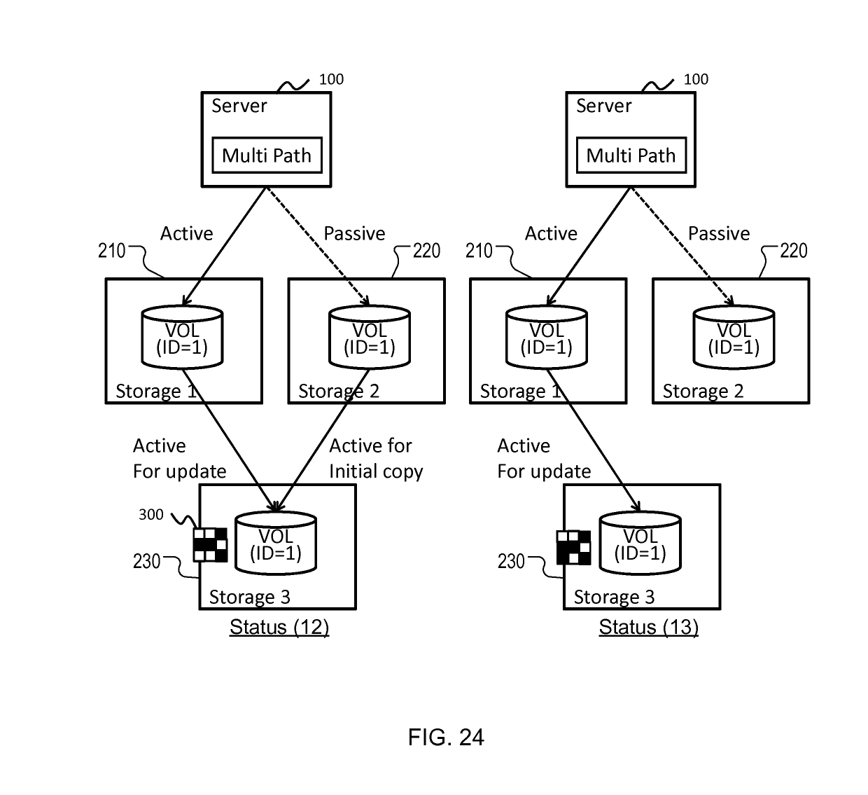

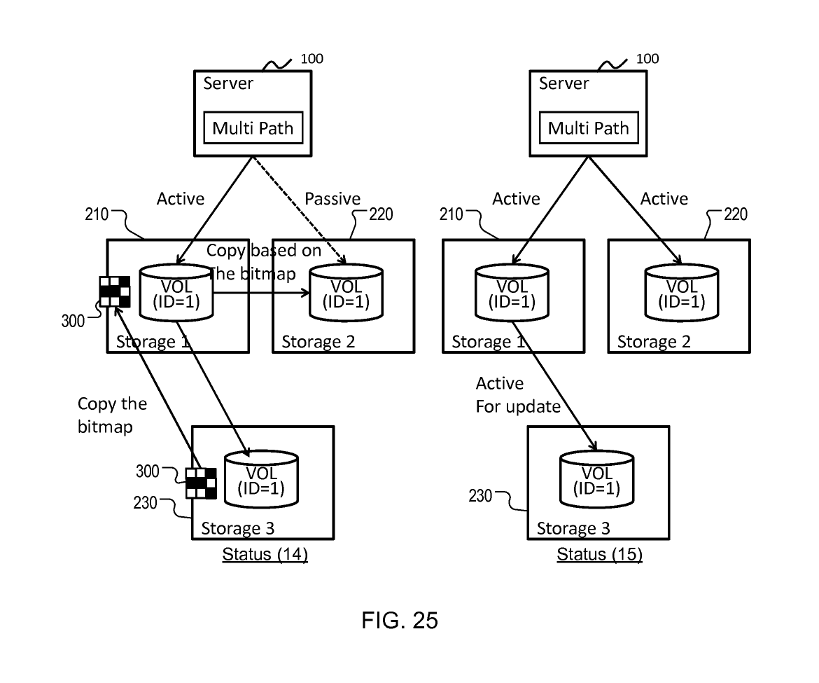

FIG. 24 illustrates example states of storage systems in accordance with one or more example implementations. When the first write process described in FIG. 16 is used, the write address is recorded in the storage system 210 but the write data is not transferred to the storage system 220. So, in a system with no remote storage system, such as the status (2) system shown in FIG. 3, if a failure occurs at storage system 210, a database recovery process may be required to recover from the old data in the storage system 220. In a system with remote storage system, a remote copy of the write data may be stored in the remote storage system. A recovery operation may be avoided.

In the status (12) system, which is described above in FIG. 22, storage system 230 is further illustrated to receive write address (e.g., from storage system 210) and store the write address as bitmap 300, i.e., the bitmap 300 is a control data for recoding the write address. The storage system 210 can also record the write address, the use of which is described in FIG. 25 with the status (14) system.

The status (13) system shows the system after the completion of the initial copy process from the storage system 220. Since the storage system 210 does not transfer the write data of a write command to the storage system 220 when the system is in status (11), (12), and (13), a process or operation synchronize the data stored in the storage system 210 and 220 is needed before changing the path status to the active and active.

FIG. 25 illustrates example states of storage systems in accordance with one or more example implementations. The status (14) system illustrates an example data synchronization process or operation. The storage system 210 copies the bitmap 300 from the storage system 230 if the storage system 210 does not have a copy of bitmap 300. Then, the storage system 210 copies data to the storage system 220 based on the bitmap. After data in a volume (e.g., volume 1) of both storage systems 210 and 220 are synchronized, both the I/O paths to storage systems 210 and 220 may be changed to active status as shown in the status (15) system. The status (15) system may be an example of a system where the volume 1 of the storage system 210 may be designated as a primary volume in a HA configuration (e.g., to reduce network cost and/or reduce remote storage cost, etc.)

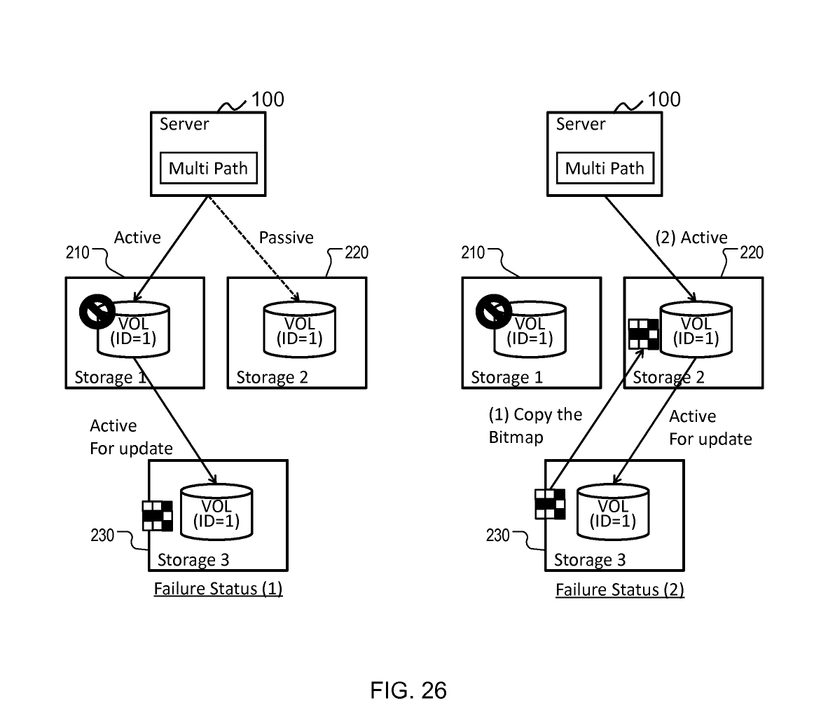

FIG. 26 illustrates example states of storage systems in accordance with one or more example implementations. The failure status (1) system illustrates a failure of the storage system 210 (e.g., a failure in the status (2), (3), or (4) systems in FIGS. 3 and 4). The difference in the failure status (1) system and the status (2), (3), or (4) systems is there is a storage system 230 with a copy of bitmap (e.g., bitmap 300). In the failure status (1) system, storage system 210 has failed and not accessible. Storage system 220 is offline (i.e., with the I/O path status being passive). Server 100 has no access to volume 1 hosted in either storage system 210 or 220.

The failure status (2) system illustrates an example process to restore access to server 100. The first operation is to ensure data stored in storage system 220 is updated. In particular, the storage system 220 copies the bitmap from the storage system 230 and copies the newest data from the storage system 230 based on the bitmap. The next operation is to change the I/O path to storage system 210 to a passive status or down status and change the I/O path to storage system 220 to active status.

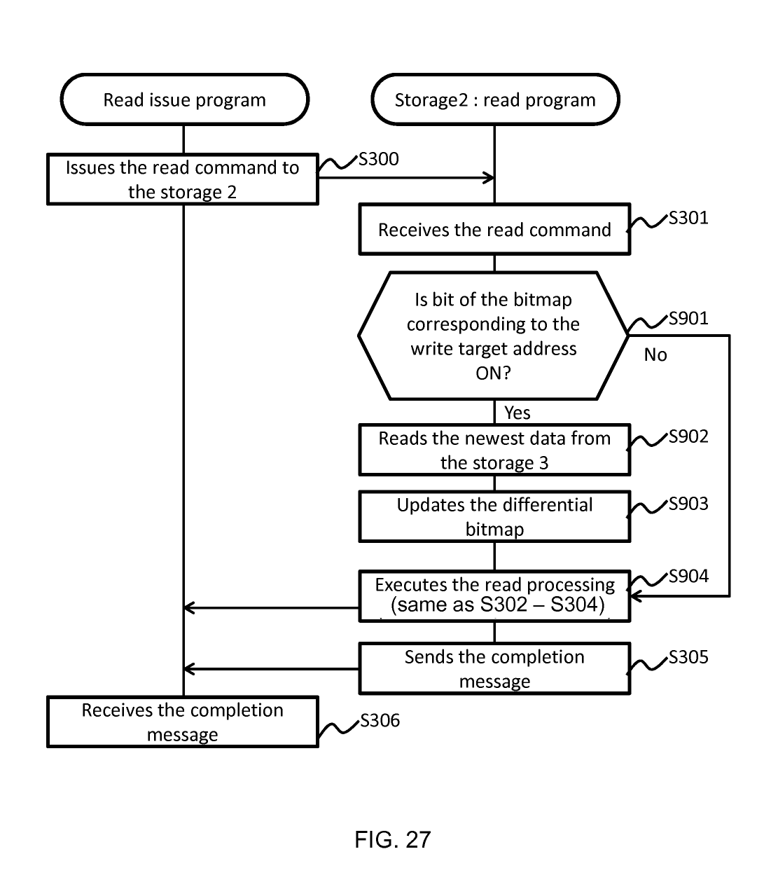

FIG. 27 illustrates an example read process in the failure status (2) system of FIG. 26 in accordance with one or more example implementations. This example read process is the same as the example read process in FIG. 14 with respect to the operations at S300-S301 and S5305-S306, except the read command is serviced by storage system 220 instead of storage system 210.

After the read command is received by storage system 220, the read program in the storage system 220 determines or confirms, at S901, whether the bit of the bitmap corresponding to the I/O target address is ON. If the bit is OFF, the read program progresses to S904 and perform read operations as described in S302-S304, FIG. 14.

If the bit is ON, the read program reads the newest data from the remote storage system 230 at S902. Then, at S903, the read program updates the bit of the bitmap corresponding to the I/O target address to OFF, and the read program progresses the operations described in S904.

Some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a non-transitory medium or a storage medium, or a computer-readable signal medium. Non-transitory media or non-transitory computer-readable media can be tangible media such as, but are not limited to, optical disks, magnetic disks, read-only memories, random access memories, solid state devices and drives, or any other types of tangible media suitable for storing electronic information. A computer readable signal medium may any transitory medium, such as carrier waves. The algorithms and displays presented herein are not inherently related to any particular computer or other apparatus. Computer programs can involve pure software implementations that involve instructions that perform the operations of the desired implementation.

Various general-purpose systems and devices and/or particular/specialized systems and devices may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A computer system, comprising:
a server;
a first storage system including:
a plurality of first storage devices, and
a first controller which provides a first volume with an identifier to the server, the first volume corresponding to a storage area of the plurality of first storage devices, and the first volume is communicatively coupled to the server through a first path with a first status, which is active; and
a second storage system including;
a plurality of second storage devices, and
a second controller which provides a second volume with another identifier same as the identifier of the first volume to the server, the second volume corresponding to a storage area of the plurality of second storage devices, and the second volume is communicatively coupled to the server through a second path with a second status, which is active;
wherein the second controller is configured to:
change the second status of the second path from active to passive; and
start executing a function on the second volume after changing the second status.

2. The system of claim 1,
wherein the second controller is further configure to change the second status of the second path from passive to active after execution of the function on the second volume, and send a completion indication to the first storage system, and
wherein the first controller is configured to:
receive the completion indication from the second controller;
change the first status of the first path from active to passive; and
execute the function on the first volume after changing the first status.

3. The system of claim 1, wherein the first controller is further configured to:
receive a write command with write data from the server;
store the write data in the first volume; and
send a write completion status to the server.

4. The system of claim 3,
wherein the first controller is further configured to:
receive a completion indication from the second storage system, and transfer the write data to the second storage system after receiving the completion indication from the second storage system.

5. The system of claim 4,
wherein the first controller is further configured to:
change the first status of the first path from active to passive and change the second status from passive to active; and
execute the function on the first volume after changing the first status.

6. The system of claim 1, wherein the first controller is further configured to:
receive a write command with write data from the server;
store the write data in the first volume;
issue another write command with the write data to the second storage system;
receive a write completion status from the second storage system; and
send another write completion status to the server.

7. The system of claim 1, wherein the function is one of a duplication function, an intra-system copying function, an inter-system copying function, a data migration function, a de-duplication function, a triplication function, a compression function, and a virus scan function.

8. The system of claim 1, wherein the first volume and the second volume store same data, and the first controller is further configured to:
receive a read command from the server;
retrieve a portion of the same data as read data from the first volume; and
send the read data to the server;
wherein the function is configured to access at least some of the same data in the second volume.

9. A computer-implemented method, comprising:
providing a first volume with an identifier to a server, the first volume corresponding to a storage area of a plurality of first storage devices, and the first volume is communicatively coupled to the server through a first path with a first status, which is active, wherein the first volume is configured to store data also stored in a second volume;
providing the second volume with another identifier same as the identifier of the first volume to the server, the second volume corresponding to a storage area of the plurality of second storage devices, and the second volume is communicatively coupled to the server through a second path with a second status, which is active; and
changing the second status of the second path from active to passive; and
executing a function, which accesses the second volume.

10. The computer-implemented method of claim 9, further comprising:
changing the second status of the second path from passive to active after execution of the function, which accesses the second volume;
sending a completion indication to the first volume;
changing the first status of the first path from active to passive; and
executing the function, which accesses the first volume.

11. The computer-implemented method of claim 9, further comprising:
receiving a write command with write data from the server;
storing the write data in the first volume; and
sending a write completion status to the server.

12. The computer-implemented method of claim 11, further comprising:
receiving a completion indication from the second volume; and
transferring the write data to the second volume after receiving the completion indication from the second volume.

13. The computer-implemented method of claim 9, further comprising:
receiving a write command with write data from the server;
storing the write data in the first volume;
issuing another write command with the write data to the second volume;
receiving a write completion status from the second volume; and
sending another write completion status to the server.

14. The computer-implemented method of claim 9, wherein the function is one of a duplication function, an intra-system copying function, an inter-system copying function, a data migration function, a de-duplication function, a triplication function, a compression function, and a virus scan function.

15. The computer-implemented method of claim 9, wherein the first volume and the second volume store same data, and the method further comprising:
receiving a read command from the server;
retrieving a portion of the same data as read data from the first volume; and
sending the read data to the server;
wherein the function is configured to access at least some of the same data in the second volume.

16. A computer program for a first storage system, comprising:
a code for responding to access from a server to a first volume with an identifier, the first volume corresponding to a storage area of the plurality of first storage devices, and the first volume is communicatively coupled to the server through a first path with a first status, which is active, wherein the first volume is configured to store data also stored in a second volume;
a code for responding to access from a server to the second volume with another identifier same as the identifier of the first volume, the second volume corresponding to a storage area of the plurality of second storage devices, and the second volume is communicatively coupled to the server through a second path with a second status, which is active;
a code for changing the second status of the second path from active to passive; and
a code for executing a function, which accesses the second volume.
